(19) United States
(12) Patent Application Publication
(10) Pub. No.: US 2025/0298154 A1
(43) Pub. Date: Sep. 25, 2025

(54) MIRROR MOUNT ASSEMBLY

(71) Applicant: Lumafield, Inc., Cambridge, MA (US)

(72) Inventors: Caroline Anne Jordan, Arlington, MA (US); Sahil Rajesh Shah, Cambridge, MA (US); Andrew Goodale, Verona, WI (US)

(21) Appl. No.: 19/058,254

(22) Filed: Feb. 20, 2025

Related U.S. Application Data
(60) Provisional application No. 63/567,718, filed on Mar. 20, 2024.

(51) Int. Cl. G01T 1/20

(52) U.S. Cl. CPC G01T 1/2002

(57) ABSTRACT

A device includes: a backing defining a plane extending in first and second directions; first through third flexures arranged in a pattern on the backing; and a mirror supported by the first through third flexures. Each flexure of the first through third flexures can have one respective unconstrained translational degree of freedom (DOF) in the plane. The mirror has an optical axis, and the unconstrained translational degree of freedom of each flexure of the first through third flexures can be perpendicular to the optical axis. The pattern can include the first flexure at a first location, the second flexure at a second location, and the third flexure at a third location, and the first through third locations are Bessel points of the mirror. The unconstrained translational DOF of the first through third flexures can be oriented to intersect at a thermal center of expansion of the mirror.

### CLAIM OF PRIORITY

This application claims priority to U.S. Provisional Application Ser. No. 63/567,718, filed on Mar. 20, 2024, the entire contents of which are hereby incorporated by reference.

### BACKGROUND

X-ray devices, such as computed tomography (CT) devices, may be used to detect defects and/or damage in an object without disassembling the object.

### SUMMARY

Some x-ray devices, such as CT devices, include a mirror to direct light toward a camera. The quality of images captured by the camera depends on the characteristics of the mirror. For example, if a mirror is distorted from a planar shape, the resolution and accuracy of images captured by the camera can suffer. The present disclosure provides a mirror mount assembly, e.g., a flexure assembly, that can reduce errors and disturbances on the shape of the mirror due to gravity, temperature variation, manufacturing imperfections, and vibratory loads.

In general, innovative aspects of the subject matter described in this specification can be embodied in a device including: a backing defining a plane extending in first and second directions; first, second, and third flexures arranged in a pattern on the backing; and a mirror supported by the first, second, and third flexures. Each flexure of the first, second, and third flexures can have one respective unconstrained translational degree of freedom in the plane. The mirror has an optical axis, and the unconstrained translational degree of freedom of each flexure of the first, second, and third flexures can be perpendicular to the optical axis. The pattern can include the first flexure at a first location, the second flexure at a second location, and the third flexure at a third location, and the first, second, and third locations are Bessel points of the mirror.

Another general aspect can be embodied in a system including: an X-ray source configured to emit X-rays; a scintillator arranged to absorb, on a first side of the scintillator, the X-rays, the scintillator being configured to emit light from a second side of the scintillator in response to absorption of the X-rays; the previously mentioned device; and a camera arranged to receive the light reflected by the mirror. The mirror can be arranged to reflect the light from the second side of the scintillator toward the camera.

Another general aspect can be embodied in a method including: installing engineered flexures on a backing at three locations corresponding to Bessel points of a mirror, thereby forming a flexure and backing assembly; disposing the mirror onto a jig disposed on a surface facing the mirror; positioning shim jigs on the mirror; placing the flexure and backing assembly on the jig supporting the mirror; installing flexure spacer jigs on the engineered flexures; injecting adhesive at adhesive injection ports on the engineered flexures; allowing the adhesive to cure, thereby forming adhesive pads contacting the backing and the mirror; removing the shim jigs from the mirror and the flexure spacer jigs from the engineered flexures; and separating the flexure and backing assembly from the jig.

These and other implementations can each optionally include one or more of the following features.

In some implementations, the unconstrained translational degrees of freedom of the first, second, and third flexures are oriented to intersect at a thermal center of expansion of the mirror.

In some implementations, the first, second, and third flexures are configured such that loads imposed on the mirror due to thermal variations in a range of 5° C. are less than 0.5 N.

In some implementations, the first, second, and third flexures are configured such that a shape of the mirror is maintained after a thermal cycle in range of 45° C.

In some implementations, the first, second, and third flexures are configured such that a shape of the mirror is maintained after accelerating up to about 29.4 m/s².

In some implementations, the first, second, and third flexures are configured such that a lowest resonant frequency of the mirror is greater than 60 Hz.

In some implementations, the pattern includes the first, second, and third flexures at first, second, and third locations, respectively.

In some implementations, the first location is on a center line of the mirror, and the second and third locations are symmetric about the center line.

In some implementations, a shape of the first flexure is symmetric about the center line.

In some implementations, the first, second, and third flexures are all a same type of flexure.

In some implementations, each flexure of the first, second, and third flexures includes a center portion and two side portions displaced from the center portion and connected to the center portion by respective intermediate portions, and the center portion is configured to move along the unconstrained translational degree of freedom, the side portions are configured to remain stationary along the unconstrained translational degree of freedom.

In some implementations, the center portion is connected to the side portions by connecting portions, and a dimensional extent of the connecting portions along the direction of the unconstrained translational degree of freedom is less than dimensional extents of the connecting portions along the two directions perpendicular to the unconstrained translational degree of freedom.

In some implementations, the device further includes adhesive pads between the mirror and the first, second, and third flexures. A material and at least one dimensional extent of each adhesive pad of the adhesive pads can provide three rotational degrees of freedom for each of the first, second, and third flexures and the adhesive pads.

In some implementations, the adhesive pads are cylindrical, having a height in range of 0.5 mm±10% and a diameter of 30 mm±10%.

In some implementations, the material of the adhesive pads has a Young's modulus of 1.1 MPa±15%, a tensile strength of 7.1 MPa, and a coefficient of thermal expansion of 370 micron/meter/° C.±50%.

In some implementations, a dimensional extent of a portion of the first, second, and third flexures is least along respective, unconstrained translational degrees of freedom of the first, second, and third flexures.

In some implementations, an angle between a direction of a portion of the light when it encounters the mirror and the optical axis is acute.

In some implementations, installing the engineered flexures on the backing includes aligning each engineered flexure with a corresponding through hole in the backing.

In some implementations, positioning the shim jigs includes: sliding alignments pins through holes in the shim jigs; and aligning recesses in the shim jigs over locations of respective adhesive pads of the adhesive pads.

Particular embodiments of the subject matter described in this specification can be implemented to realize one or more of the following advantages. In some implementations, using the described mirror mount assembly can improve the quality of images captured by a CT device. In some implementations, the lifespan of the mirror and X-ray device can be extended by preventing damage to the mirror due to thermal, weight, and vibratory variations. For example, the shape of the mirror, e.g., a flat rectangle with a fixed aspect ratio, can barely change, e.g., less than a micron, throughout these variations.

In some implementations, the cost of assembling the mirror mount assembly can be reduced by using similar flexures, thereby reducing the cost compared to producing multiple, unique flexures.

### BRIEF DESCRIPTION OF THE DRAWINGS

FIG. 1 depicts an example of an X-ray device.

FIG. 2A depicts an example of a flexure assembly.

FIG. 2B is a diagram illustrating two-dimensional Bessel points.

FIG. 2C depicts another example of a flexure assembly.

FIG. 3 depicts an example of a flexure from the flexure assembly of FIG. 2A.

FIG. 4 depicts an assembly, and FIG. 5A depicts a flowchart for a method of constructing the assembly of FIG. 4.

FIGS. 5B, 5C, 5D, 5E and, 5F depict components of the assembly during the method of FIG. 5A for constructing the assembly.

### DETAILED DESCRIPTION

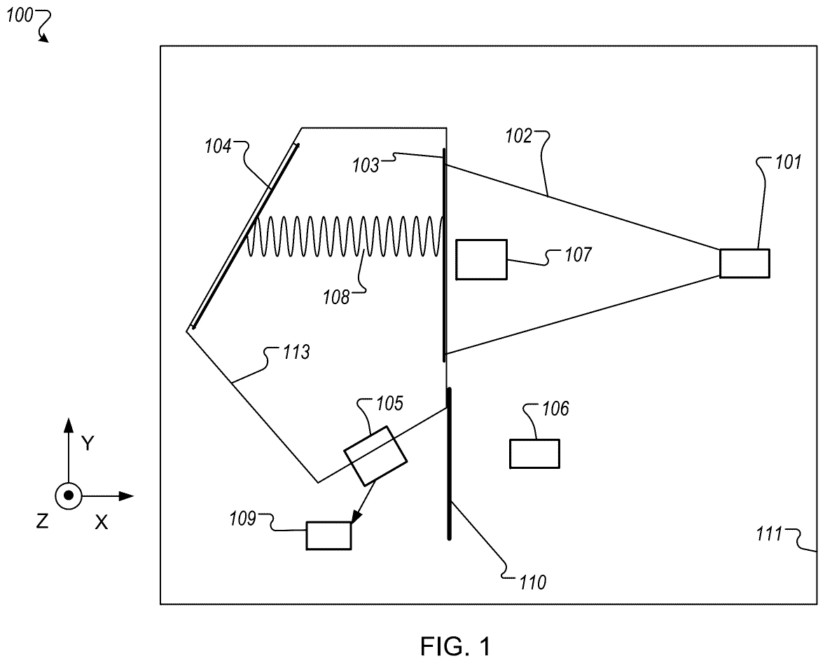

FIG. 1 depicts an example of X-ray device 100. X-ray device 100 includes X-ray source 101 configured to emit X-rays 102 towards scintillator 103. As X-rays 102 pass through scan target 107 and collide with scintillator 103, the scintillator 103 emits light 108. A mirror assembly 104 reflects the light 108 towards camera 105.

The X-ray source 101 is an apparatus that emits X-ray radiation. The scintillator 103 can include a material that emits visible, ultraviolet, and/or infrared light when excited by X-ray radiation. Camera 105 can be an apparatus or device configured to detect visible, ultraviolet, or infrared light. In some implementations, X-ray device 100 includes a motion system 106 configured to move, reposition, manoeuvre, or otherwise manipulate the scan target 107 relative to the X-ray source 101 (e.g., the X-ray source 101 can be moved in some implementations) or a mount 113.

The mount 113 supports the scintillator 103, the mirror assembly 104, and the camera 105. An enclosure 111 surrounds the X-ray source 101, the scintillator 103, the mirror assembly 104, the camera 105, the motion system 106, the scan target 107, and the mount 113, as well as other components of the X-ray device 100.

In some implementations, the camera 105 includes an optical camera, a charge-coupled device (CCD) camera, a photodiode, or any combination thereof. For example, an optical camera can include a complementary metal-oxide-semiconductor (CMOS) digital camera sensor. Alternatively or additionally, an optical camera can include a red-green-green-blue (RGGB) Bayer filter and/or a monochromatic optical camera. In some examples, an optical camera can include a back-side-illuminated sensor and/or front-side-illuminated sensor. As an example, camera 105 can be configured to detect infrared light, ultraviolet light, and/or visible light 108.

In some implementations, camera 105 is positioned on the opposite side of scintillator 103 and shroud 110 from X-ray source 101 such that the shroud 110 blocks and protects camera 105 from stray visual light and/or X-rays 102 emitted from X-ray source 101. The shroud 110 can be a covering that blocks visible, ultraviolet, and/or infrared light from reaching the camera 105. Stray light is visible light, infrared light, and/or ultraviolet light that affects the camera by contributing noise above the read-noise of the camera.

The camera 105 can be configured to generate data (e.g., radiographs) using detected light. In some implementations, the data includes an intensity and wavelength of light for each pixel. The computer 109 can be configured to execute an algorithm for 3D reconstruction that uses the data (and optionally known information about the geometry of the arrangement of the X-ray source 101, scintillator 103, the mirror assembly 104, the camera 105, and the scan target 107) in order to reconstruct a 3D model of the scan target 107 based on the light produced by the scintillator 103. By mapping the location of where a particular light ray originated on the scintillator 103to a pixel location or voxel location for 3D images, the computer 109 can associate an orientation, e.g., direction of a light ray, for the light entering the camera 105. In some implementations, the algorithm for 3D construction assumes that the mirror in the mirror assembly 104 is flat. Accordingly, the mirror being deformed can negatively impact image reconstruction. More details regarding the set up of the X-ray device can be found in U.S. patent application Ser. No. 17/987,705 and U.S. patent application Ser. No. 18/232,688.

In some implementations, the mirror in the mirror assembly 104 is a fold mirror, e.g., the mirror is oriented to “fold” a field of view of the camera 105 to reduce a total volume of the detector assembly. The fold mirror can be oriented non-vertically, e.g., the plane of the mirror intersects the vertical direction. For example, an angle between incoming light and a normal vector of the mirror, e.g., the optical axis of the mirror, is acute. As a result, the fold mirror can be subject to gravitational forces that distort the shape of the mirror, e.g., make the mirror nonplanar, e.g., depending on the orientation, length, thickness, material, and mounting of the mirror.

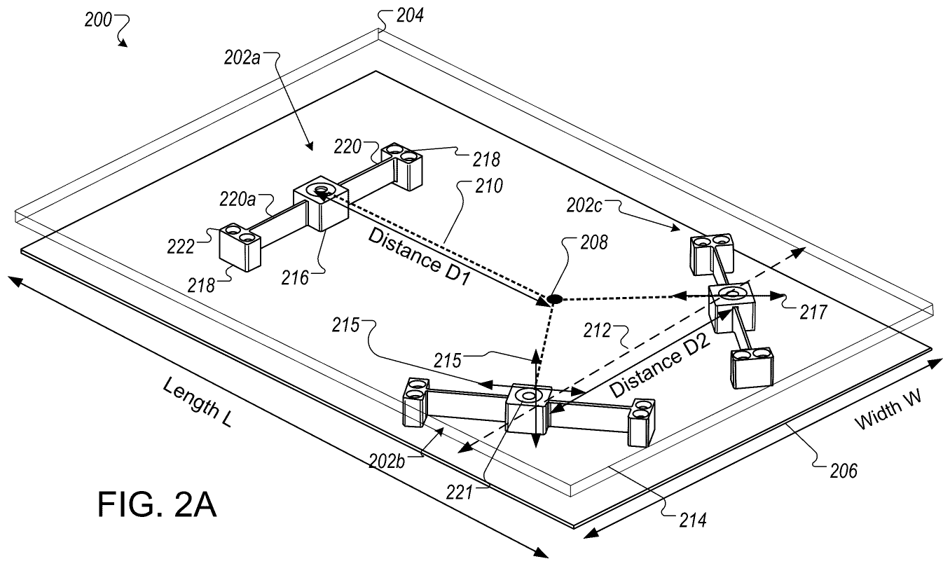

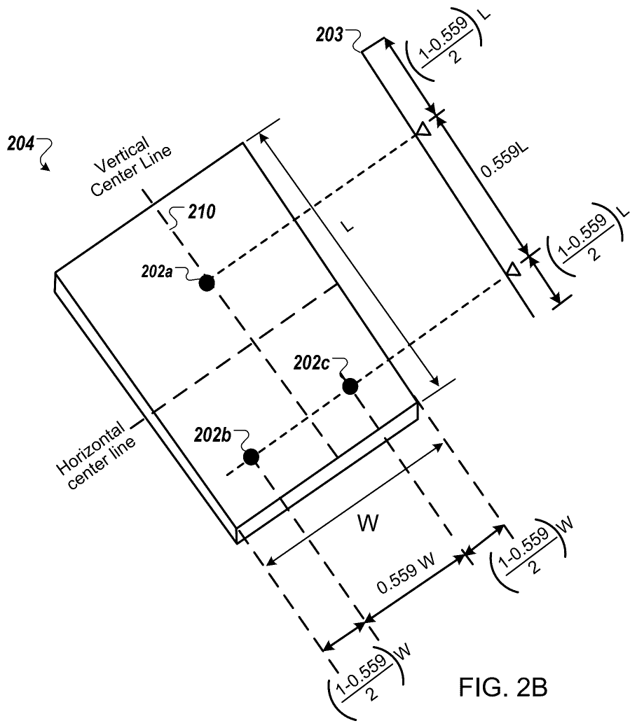

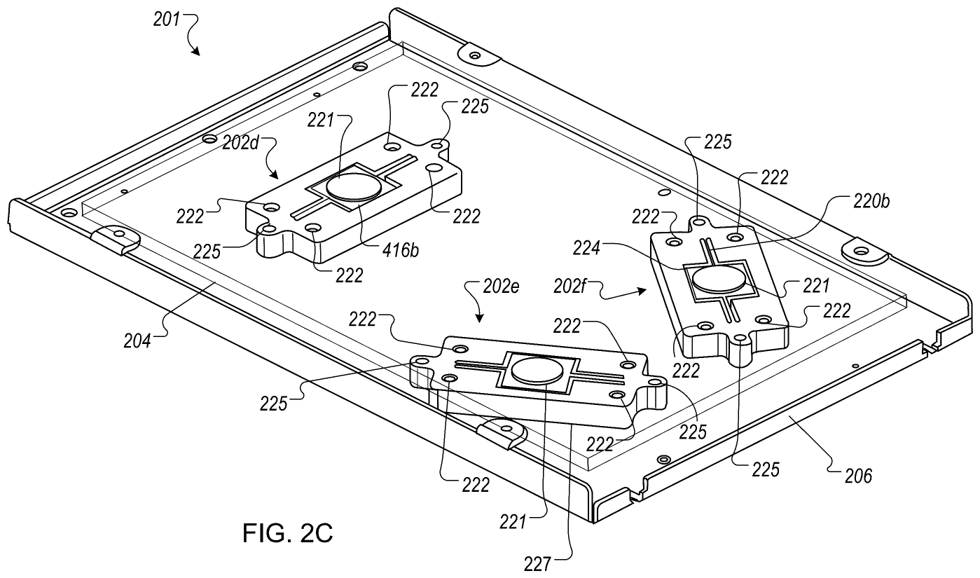

With reference to FIG. 2A, mounting the mirror with a flexure assembly 200 can prevent problems related to distortion of the mirror. The flexure assembly 200 includes three flexures 202a, 202b, and 202c. The flexures 202a-202c mount a mirror 204, e.g., the mirror from the mirror assembly 104, to a backing 206. For convenience, the mirror 204 has been depicted as being transparent so the backing 206 and flexures 202a-202c are visible.

Using the flexure assembly 200 prevents issues related to the mirror 204 and the backing 206 having different coefficients of thermal expansion (CTE), e.g., CTE mismatch. For example, the backing 206 can be made of steel, and the mirror 204 can be made of glass with a reflective layer. The CTE of steel is three times higher than that of glass, so bonding the steel directly to glass would result in severe warping of the mirror 204 under thermal fluctuations. Generally, materials with a CTE closer to that of glass that could be used as the backing are expensive.

The flexures 202 in the flexure assembly 200 are arranged in a pattern according to Bessel points of the mirror 204. In this specification, Bessel points refer to locations for mounting a rectangular, planar object that minimize distortion due to self-weight. In general, Bessel points refer to two-dimensional or three-dimensional representations, and the Bessel points in this specification are described based on their location in a plane parallel to the mirror 204. For example, the locations of the mounting positions in the flexure assembly can correspond to Bessel points of the mirror 204, e.g., the mounting positions are arranged in the same pattern as the Bessel points of the mirror but in the plane of the backing 206.

With reference to FIG. 2B, the Bessel points are determined based on the dimensions of the mirror 204. For example, the mirror 204 can have a length L and a width W. In one dimension, e.g., along a single axis 203 parallel to the length direction, the Bessel points along a line with length L are spaced D1=0.559 L apart from each other, e.g., (1-0.559)L/2 from edges of the line. Projecting these two Bessel points onto the two-dimensional surface of the mirror can yield three points, where the distance along the length direction between the first flexure 202a and either of the second and third flexures 202b and 202c along the length direction is D1=0.559 L. Three points are used to achieve an exact constraint design, which will be discussed later on.

Similarly, each of the first, second, and third flexures 202a, 202b, and 202c are disposed equally spaced from the edges of the mirror 204, e.g., (1-0.559)L/2, along the length direction.

The first flexure 202a can be disposed along a center line 210 of the mirror 204 along the length direction, such that the first flexure 202a is equally spaced from edges of the mirror along the width direction.

The locations in the width direction of the second and third flexures 202b and 202c can similarly be determined using Bessel points. The distance along the width direction between the second flexure 202b and the third flexure 202c can be selected to be D2=0.559 W. The second and third flexures 202b and 202c can be disposed such that the second and third flexures 202b and 202c are equally disposed from edges of the mirror, e.g., (1-0.559)W/2, along the width direction. The second and third flexures 202b and 202c are arranged to be symmetric about the center line 210.

Using the above selections for the pattern of the flexure assembly 200, the first flexure 202a at a first location is on the center line 210 of the mirror 204, and the second and third flexures 202b and 202c are at second and third locations that are symmetric about the center line 210, e.g., have a reflection symmetry about the length direction.

In general, objects have 6 degrees of freedom (DOF), e.g., three translational DOF and three rotational DOF. For example, when the flexures 202a-202c are not fixed to the backing 206, two directions of the translational DOF are in the plane of the mirror 204 and the third translational DOF is out-of-the-plane of the mirror 204. The orientation of the planar, translational DOFs depend on the orientation of the flexure 202. For example, for the first flexure 202a, the two planar, translational DOF are along the length and width directions, and the out-of-the-plane translational DOF is along a direction perpendicular to both the length and width directions.

For each of the first, second, and third flexures 202a-202c, a first translational DOF is selected to be along the lines connecting the flexures to the center of thermal expansion 208, respectively. When unattached to the backing, a second translational DOF is perpendicular to the first translational DOF and in the plane of the mirror 204, and a third translational DOF is perpendicular to both the first and second translational DOF, e.g., out-of-plane relative to the mirror 204.

When attached to the backing 206, the flexure assembly 200 includes constraints on the translational DOF. For example, each flexure 202a-202c has one unconstrained translational DOF and two constrained translational DOF, e.g., constraints. In this specification, unconstrained translational DOF does not mean there are no limits on motion in that direction, e.g., although a flexure has one “unconstrained translational DOF,” motion in that direction can still be limited to within a predetermined range. An object having a constrained translational DOF or constraints means that the object is designed to not move (or move negligibly) in that direction.

For each flexure 202a-202c, the unconstrained translational DOF is the direction from the center of the respective flexure toward the center of thermal expansion 208. The unconstrained translation DOF is along a direction toward the center of thermal expansion because this minimizes the amount of energy required to physically deform the flexures 202 and mirror 204 when undergoing thermal expansion. For example, flexure 202a has an unconstrained translational DOF along the length direction, a constraint along the width direction, and a constraint along the out-of-plane direction. Accordingly, the directions of the combined three unconstrained, translational DOF of the flexures 202 combine at the center of thermal expansion 208. In some implementations, the center of thermal expansion is located along the center line 210 (centered in the width direction). For example, the center of thermal expansion can also be centered in the length direction, e.g., the center of thermal expansion corresponds to the center of a rectangle with dimensions of the mirror 204. In FIG. 2A, the center of thermal expansion is displaced from the center of the mirror in the length direction, which can occur when the mirror 204 is designed to achieve a target global stiffness profile.

The dimensions of the connection portions 220 of the flexures 202a-202c contribute to how constrained a translational DOF in a given direction is. For example, using flexure 202a as an example, the connecting portions 220a have a height and material properties that are sufficient to suppress movement in the out-of-plane direction. Similarly, the width of the connecting portions 220a along the width direction is great enough to suppress movement in the width direction. For example, movement in the width direction results in tension or compression of the connecting portions 220a.

The dimensional extent of the connecting portion 220a along the length direction, e.g., direction of the unconstrained translational DOF, is thin enough that the connecting portions can warp along the length direction, leading to there being an unconstrained translational DOF in the length direction for flexure 202a. In other words, the geometry of the flexures is designed to reduce stiffness in the unconstrained translation DOF. The degree of suppression in the length direction and out-of-plane direction is affected by the bending stiffness of the connection portion 220. The relative degree of suppression in the unconstrained translation vs. the out-of-plane direction scales as (thickness/height) 2. Accordingly, selecting the thickness to be less than the height is beneficial.

In this specification, a flexure refers to a flexible element or combination of elements engineered to be compliant in specific DOFs. A basic flexure can be a general, off-the-shelf product, and an engineered flexure can be a flexure that includes one or more elements, which are combined to modify the physical behaviour of the flexure. A flexure assembly refers to any combination of two or more flexures that work together in a device.

As another example, with reference to FIG. 2C, another flexure assembly 201 can include flexures 202d-202f. Similarly to flexures 202a-202c, flexures 202d-202f only have one unconstrained translational DOF in a direction toward the center of thermal expansion and two constraints. Instead of the area surrounding holes 222 only being on the side portions 218 as in FIG. 2A, the flexures 202d-202f have a metallic portion 227 that extends completely around the adhesive pads 221. The presence of the metallic portion 227 limits the range of motion of the flexure to keep the stress below a threshold, e.g., 20% of its yield strength, to avoid damaging the flexure. The range of motion what would involve engaging the metallic portion 227 is far beyond what is expected during normal or even extreme operation.

Each flexure 202d-202f can have grooves 224 on opposite sides of a central portion 416b allowing for motion of the central portion 416b along the unconstrained translation DOF. Consequently, each central portion 416b can translate through a range determined by the width of the grooves 224. Connecting portions 220b connect the central portions 416b to the rest of the flexures. Similarly to connecting portions 220a, connecting portions 220b have a narrow dimensional extent, e.g., width, along the direction of the unconstrained translational DOF.

Compared to flexures 202a-202c, flexures 202d-202f include cavities 225 on opposite edges for receiving alignment pins when being assembled. There is room in the flexures 202d-f for the cavities 225 since due to the surrounding metallic portion 227. In some implementations, using alignment pins in the flexures can improve accuracy, reduce the assembly time, or both when assembling a device including the flexure assembly 201. In general, using the flexures 202d-202f can reduce stress on the flexure and protect the connecting portions 220b during assembly.

In some implementations, the flexure assemblies 200 and 201 include adhesive pads 221, which are disposed on surfaces of the flexures. In some implementations, the adhesive pads have circular surfaces, e.g., are cylindrical prisms.

Each adhesive pad 221 has three rotational DOF. The dimensional extent, i.e., the length in a given direction, of the adhesive pads 221 determines (along with the compliance of the material(s) used) how much an object being supported, e.g., mirror 204, can rotate. For example, the adhesive pad 221 can be designed to have a structural stiffness that allows for some compliance, thereby allowing an object supported by a flexure to slightly rotate along any of three mutually orthogonal axes. Accordingly, an object supported by each flexure has exactly two constraints, e.g., flexure 202b has two constrained translational DOFs 215, flexure 202c provides one unconstrained translational DOF 217, and the adhesive pads 221 provide three unconstrained, e.g., more compliant, rotational DOFs. In this example, each of the flexure assemblies 200 and 201thereby includes six total constraints, e.g., two constraints per engineered flexure, and is “exactly” constrained. Accordingly, using more than three mounting locations would over-constrain the design, and using two or one mounting locations would under-constrain the design.

The adhesive pads 221 can be engineered to provide the three rotational DOFs with a certain range of tolerance. While the adhesive pads 221 allow for rotation in any direction, there is a limit to how much the adhesive pads can rotate, e.g., 0.04 radians about an axis in the plane of the mirror 204 and 0.003 radians along the normal of the mirror.

Structural and material parameters of the adhesive pads 221 can determine the stiffness, the strength, and coefficient of thermal expansion of the adhesive pads 221. The size, e.g., dimensional extent in three dimensions, of the adhesive pads 221 in part determines the range of the rotational DOFs. For example, the height of the adhesive pads 221 determines a maximum angular range through which an object mounted on a corresponding flexure can rotate in one angular DOF. Similarly, the width and depth of the adhesive pads 221 impact the range of the other two angular DOF. In some implementations, the adhesive pads have a cylindrical shape, e.g., have a circular cross section, with the following dimensional extents: a height of about 0.5 mm±10% and a diameter of about 30 mm±10%.

The material parameters of the adhesive pads 221 also impact the range of the angular DOFs. For example, the Young's modulus can be 1.1 MPa±15%, the tensile strength can be 7.1 MPa (above 0.35 MPa), and the CTE can be 370 micron/meter/° C.±50%. In some implementations, the adhesive pads 221 include cured epoxies and room-temperature-vulcanizing (RTV) silicone. Factors such as curing time, curing temperature, coefficient of thermal expansion, outgassing coefficients, shrinkage coefficients, and toxicity can impact adhesive selection.

In some implementations, the material of adhesive pads 221 is selected based on a resonant frequency of the material of the flexures. Generally, the more compliant the flexure assembly 200 is, the more the flexure assembly 200 can redistribute loads to prevent deformation of the mirror 204. However, capping the compliance to ensure a minimum natural frequency of the flexure assembly 200 can prevent external vibrations from negatively impacting scanning accuracy. During operation, the X-ray device 100 can be exposed to various vibrations, which puts the X-ray device 100 at risk of deforming if the vibrations are at a resonant frequency of components within the X-ray device. For example, equipment that vibrates at 60 Hz is often found in labs or shops. The geometry and material selection of the adhesive pads 221 and the flexures can be selected to be sufficiently high such that the lowest natural frequency of vibrations of the mirror is greater than 60 Hz.

In some implementations, a spring model can determine first order values for the resonant frequencies of the flexure assembly 200. For example, the spring stiffness along the width direction can be on the order of 1000 N/mm or more, e.g., 12333 N/mm or 1683 N/mm, the spring stiffness along the length direction can be 1000 N/mm or more, e.g., 14583 N/mm or 1367 N/mm, and the spring stiffness in the out-of-plane direction can be greater than the spring stiffness and the length and width directions, e.g., 2027 N/mm or 8764 N/mm. In some implementations, the spring stiffness in all three directions can be about 851 N/mm. In some implementations, finite element analysis can be used to determine the natural frequencies of the mirror 204 as a function of location within the mirror.

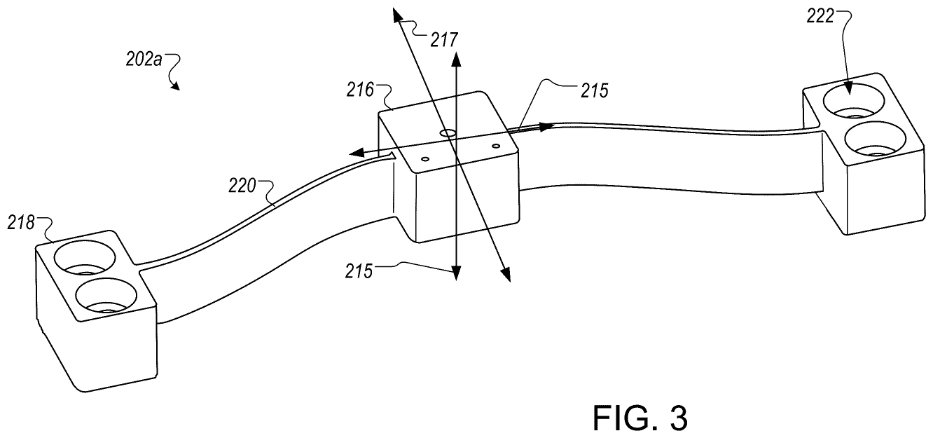

In some implementations, the three flexures 202a-202c can be the same type of flexure, e.g., have the same geometry, the same material properties, the same stiffnesses in all three translational and three rotational degrees of freedom, or a combination thereof. For example, with reference to FIG. 3, each flexure 202 can include a central portion 216 and side portions 218. Connecting portions 220a can connect the central portion 216 to respective side portions 218. Each flexure 202 can have two reflection symmetries, e.g., along a line parallel to connecting portions 220a and along a line perpendicular to the line parallel to the connecting portions 220a and centered in the middle of the central portion 216. However, other geometries are possible.

In some implementations, flexures 202a-202f include holes 222. Fasteners can extend through the holes 222 to mechanically couple the flexures 202a-202f to the backing 206. The central portions of the flexures 202a-202f are not fastened to the backing 206, thereby affording the central portion 216 the ability to move along the unconstrained DOF.

In some implementations, the central portion 216 of the flexures 202a-202c can have an unconstrained translational DOF, while the side portions 218 are constrained in all three translational DOF due to the mechanical coupling to the backing 206 via fasteners extending through holes 222. For example, due to mechanical or thermal stress, the flexures 202a-202c can experience distorting forces. In response to these distorting forces, the central portion 216 can displace along the unconstrained translational DOF, while the side portions 218 remain stationary. The connecting portions 220a can warp from having a straight profile to having a curved profile, e.g., like an S-curve as depicted in FIG. 3. The flexure 202 can be configured for the central portion 216 to have a maximum displacement of 0.3 mm, which corresponds to 78.7 MPa, e.g., 17.6% of yield stress.

By allowing the central portion 216 to translate in one dimension, the connecting portions 220a to warp in response to applied stresses, and the mirror 204 to not be subject to imposed loads due to thermal expansion of the backing 206 during temperature changes, the flexure assembly 200 reduces the load on the mirror 204. For example, the maximum stress in the mirror can be 1.923e+04 N/m², the maximum stress in the adhesive pads can be 1.804 e+04 N/m², and the maximum stress in the flexures can be 5.31 e+06 N/m². These maximum stresses are considerably lower than the stress that would result in failure for these components, e.g., 5.8 e+04 N/m²±10-30% or 40e+04 N/m²±10-30% for the mirror and 6.3e+04 N/m²+10-30% or 43e+04 N/m²+10-30% for the adhesive pads.

Although the examples so far have included mirror 204, other optical components can be mounted using the provided flexure assembly 200. For example, the flexure assembly 200 can support an optical filter or a lens, where the portion of the lens being used to alter light is located within the locations of the flexures.

Using the described flexure assembly 200 can provide many benefits. For example, the locations of the flexure assembly 200 can be selected to minimize or at least reduce distortion of the mirror from self-weight. For example, simulations using finite element analysis suggest that supporting a given mirror 204 (with a length of 390 mm, a width of 256 mm, and thickness of 6 mm) on opposing ends yields 8.6 μm of deflection at the center of a mirror, while supporting the mirror at the described Bessel points yields only 0.7 μm of deflection at the center of the mirror, e.g., a 12.3 times improvement in mirror deformation. As another example, other simulations indicate that a mirror 204 supported on edges of the mirror yields 20 μm of deflection at the center of the mirror, while supporting the mirror at the described Bessel points yields only 0.5 μm of deflection at the center of the mirror.

Using the disclosed flexure assembly can change the location of maximum distortion from mounting compared to a conventionally mounted mirror. For example, for the previous example of a mirror mounted at opposing edges, the maximum deflection, e.g., 8.6 μm, occurs at the center of a mirror with dimensions of 390 mm by 256 mm by 6 mm. For a mirror mounted at the Bessel points, the maximum deflection, e.g., 2.5 μm, occurs at the corners of the mirror closest to the flexure 202a and/or flexure 202d, and only 0.7 μm of deflection occurs at the center of the mirror. Note that the corners of the mirror in a CT device may not participate in reflect light used to reconstruct a three-dimensional model of the scan target 107 from the radiographs. Consequently, using the disclosed flexure assemblies 200 and 2021 can advantageously shift distortions to regions of the mirror that do not negatively impact image quality. In general, mounting at the Bessel points compared to the edges of the mirror can reduce mounting-induced deformation.

In some implementations, forces that arise from the thermal mismatch between the backing 206 and the mirror 204 as both expand can be limited to less than 0.5 N for a temperature range of 5° C. In some implementations, using the flexure assembly 200 can result in as little as 0.2 microns of deflection after an 5° C. increase in temperature.

In some implementations, the mirror 204 can maintain the same shape after cycling through a 45° C. range of temperatures, which can occur during shipping. For example, thermal expansion can generally induce hysteresis in objects, e.g., deformation in the shape of the mirror 204 after cycling through a variable such as temperature. In an experiment to test how much radiation reflected off the mirror is displaced based on distortion caused by thermal expansion, a checkerboard can replace the scintillator, and a mirror is mounted at the Bessel points. After the first mirror cycles through the temperature range, the mean corner displacement of each corner of a 10 mm×10 mm checkerboard is only 0.001 pixels, e.g., the corners of the checkerboard appearing in an image a camera capturing an image of the mirror undergo thermal walk of about 0.001 pixels (assuming 10 μm corresponds to a 2×2 pixel grid).

While being shipped, the mirror 204 can experience up to 29.4 m/s² of acceleration (about three times the strength of gravity). In some implementations, damping foam can pad the flexure assembly during shipping to further protect the mirror 204 while shipping.

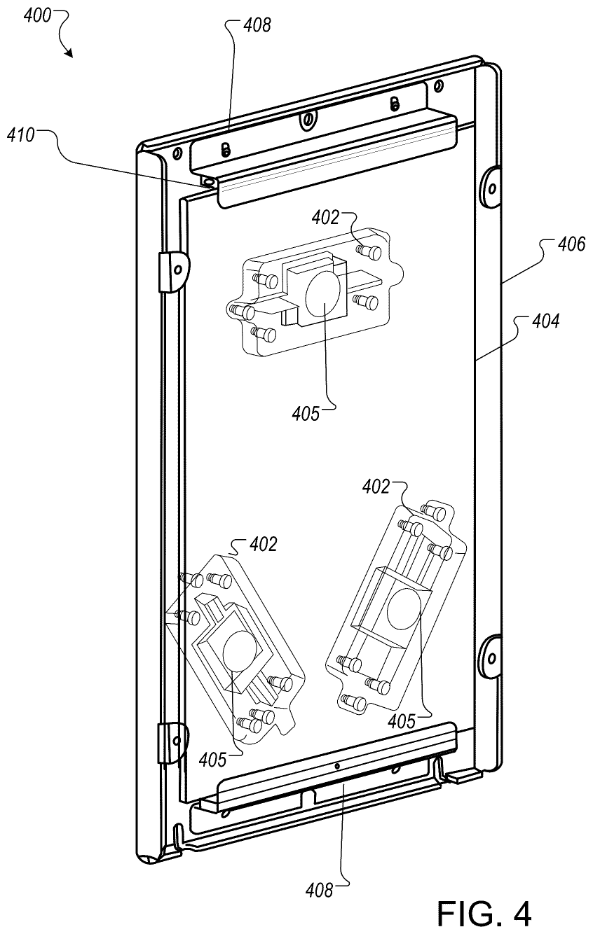

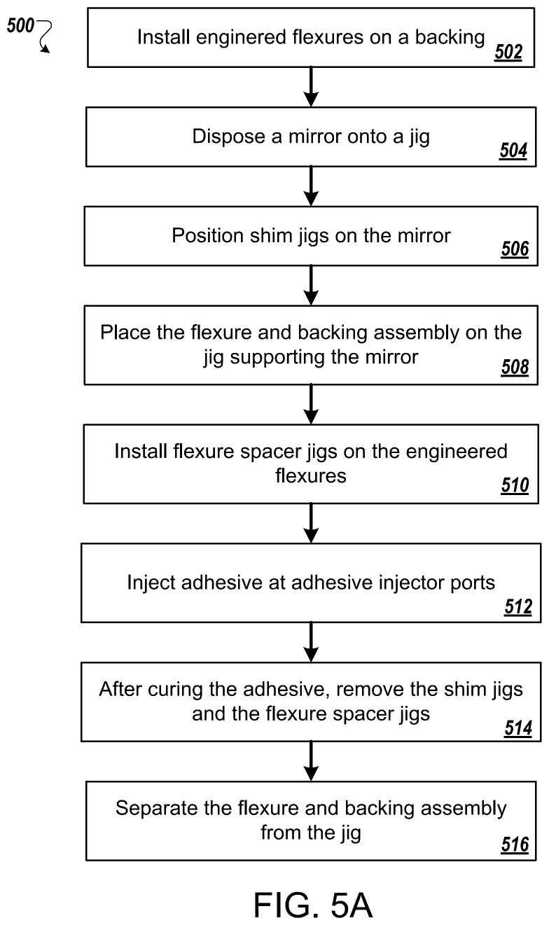

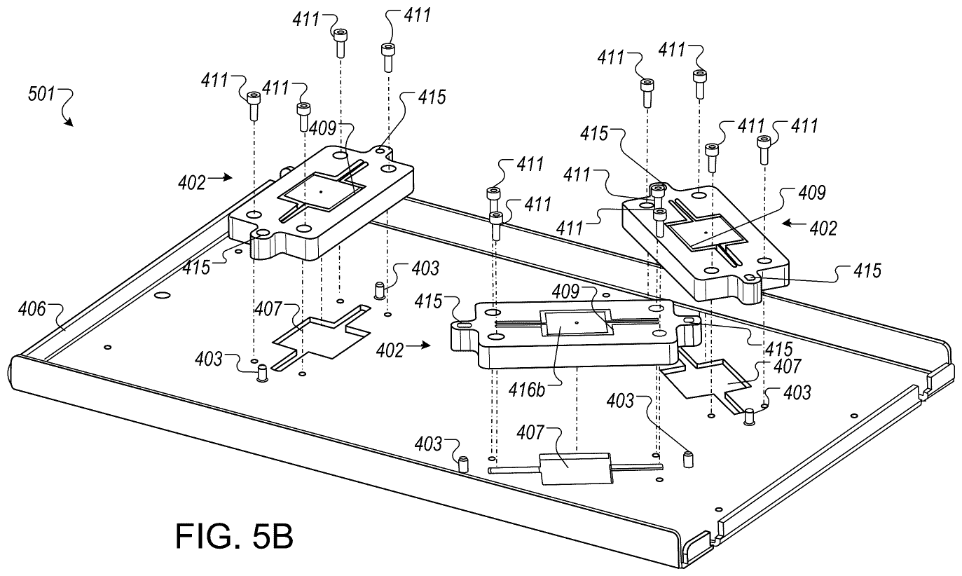

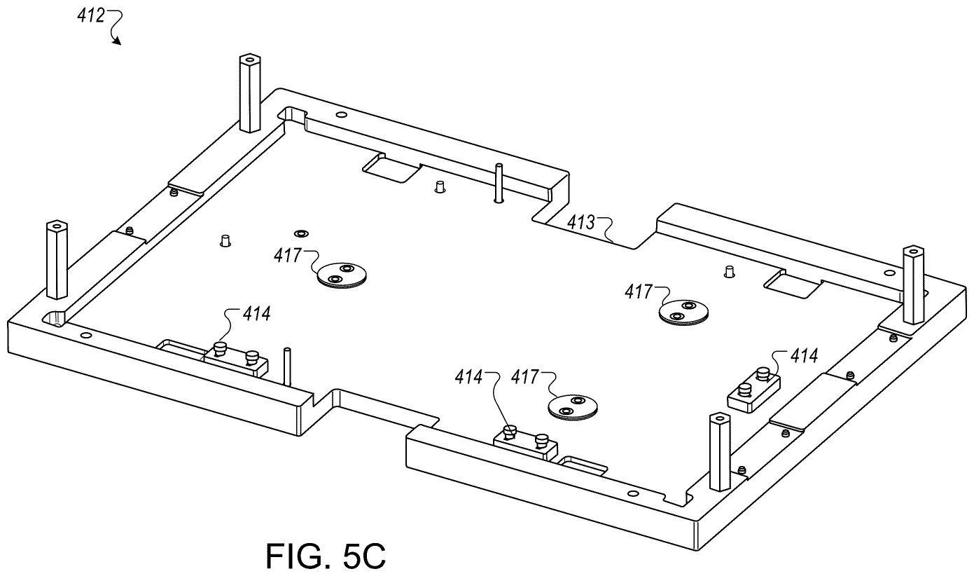

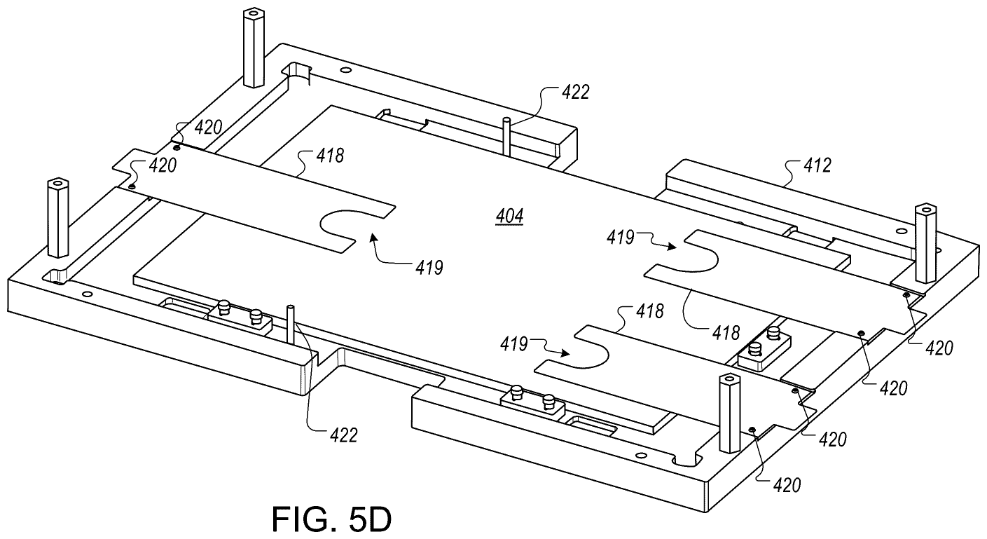

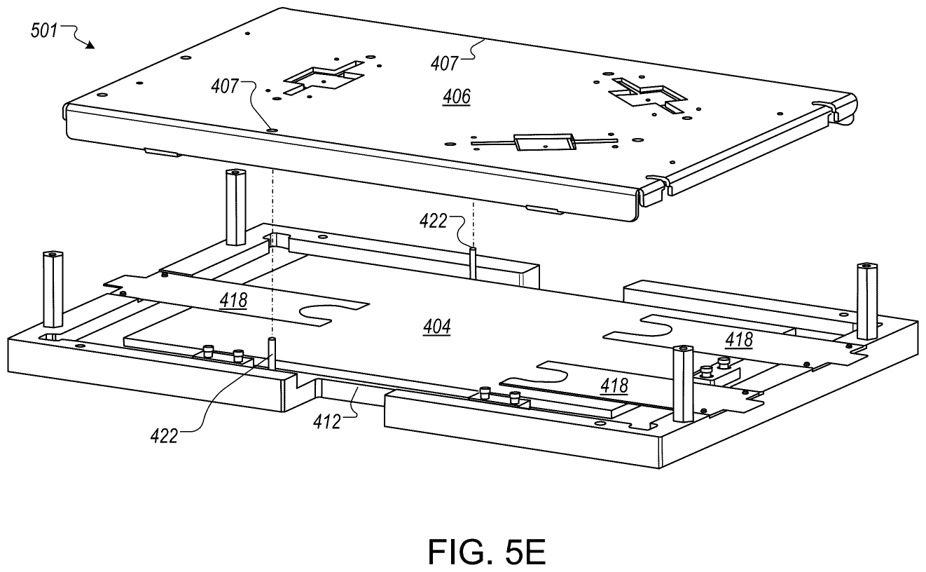

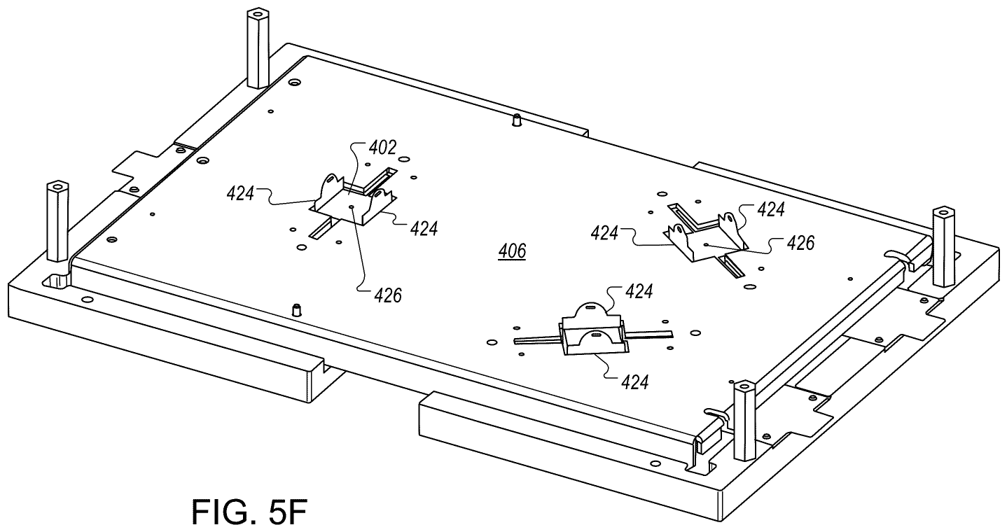

FIG. 4 depicts an assembly 400, and FIG. 5A depicts a flowchart for a method 500 for constructing the assembly 400. FIGS. 5B-5F depict components of the assembly 400 throughout the method 500. The assembly 400 includes engineered flexures 402, a mirror 404, adhesive pads 405, a backing 406, safety catches 408, and shipping foam 410. In some implementations, the engineered flexures 402 can be the flexures 202d-202f, the mirror 404 can be the mirror 204, the adhesive pads 405 can be the adhesive pads 221, the backing 406 can be the backing 206, or a combination thereof.

The method 500 begins with installing engineered flexures 402 onto the backing 406 (502). As depicted in FIG. 5B, in a flexure and backing assembly 501, the backing 406 has through holes 407 sized and shaped similarly to grooves 409 within the engineered flexures 402. The through holes 407 are slightly larger than the grooves 409 to provide the unconstrained, translation DOF.

Both the engineered flexures 402 and the backing 406 can include additional holes that align with the engineered flexures 402. The engineered flexures 402 are fastened to the backing 406, e.g., using bolts 411. For example, installing the engineered flexures 402 on the backing 406 can include aligning each engineered flexure 402 with a corresponding through hole 407 in the backing 406 using corresponding alignment pins 403 that fit within cavities 415 of the engineered flexures 402.

The method 500 continues with disposing the mirror 404 onto a jig 412 (504). With reference to FIG. 5C, the jig 412 can include a support layer 413, alignment pins 414, and support pads 417. The support pads 417 are attached to the jig 412 and support the mirror 404 (not depicted in FIG. 5C), e.g., the support pads 417 face the side of the mirror 404 with a reflective coating. The support pads 417 reduce the chance of the mirror 404 warping during assembly.

In some implementations, the jig 412 includes spring plungers, which exert a light pressure on the mirror 404 to maintain the mirror 404 in the same position once disposed on the jig 412.

The method 500 continues with positioning shim jigs 418 on the mirror 404 over locations corresponding to adhesive pads for the engineered flexures 402 (506). With reference to FIG. 5D, the shim jigs 418 are positioned using the alignment pins 414. Each shim jig 418 has defines a hole through which an alignment pin 420 can slide. In some implementations, magnets, which can have a groove for receiving an alignment pin, can hold the shim jigs 418 in place.

In some implementations, the shim jigs 418 have a “T” shape, e.g., a wider portion connected to a narrow portion. A portion of each shim jig 418 (e.g., the narrow portion of the “T” shape) can have a recess 419 (e.g., on the edge of the narrower portion not connected to the wider portion) shaped to surround an adhesive pad for a corresponding engineered flexure 402, where the positioning of the shim jig 418 ensures the engineered flexures 402 are properly spaced from the mirror 404 to achieve the proper height of the adhesive. The shim jigs 418 do not physically make contact the adhesive.

The method 500 continues with placing the flexure and backing assembly 501 on the jig 412 supporting the mirror 404 (508). With reference to FIG. 5E, in some implementations, placing the flexure and backing assembly on the jig 412 supporting the mirror 504 includes using alignment pins 422 on edges of the jig 412 that align with recesses or through-holes in the backing 406. The alignment pins 422 ensure that the location of the flexure and backing assembly 401 is accurate relative to the location of the mirror 404 within the jig 412.

The method 500 continues with installing flexure spacer jigs 424 on the engineered flexures 402 (510). With reference to FIG. 5F, the flexure spacer jigs 424 can be disposed in the grooves 409 (not visible in FIG. 5F) of the engineered flexures 402. The flexure spacer jigs 424 can include pairs of sheets that fit within grooves 409 on opposing sides of the engineered flexures 402 and extend above the surface of the backing 406. The flexure spacer jigs 424 ensure that the central portions remain centered during adhesive application and cure so that the central portions will be able to translate along the unconstrained translational DOF upon assembly completion.

The method continues with injecting adhesive at injection ports 426 on the engineered flexures 402 (512). The adhesive can be an epoxy or RTV silicon that cures over a predetermined time period. The recesses 419 are sized and shaped for forming the adhesive pads. Adhesive material is injected through the injection ports 426 and forms circular adhesive pads 405. The adhesive naturally dispenses in a circular shape when injected through the injection port 426, as the adhesive is following the path of least resistance, e.g., expanding uniformly radially outward.

The method continues with removing shim jigs 418 and flexure spacer jigs 424 after the adhesive has cured (514), e.g., after 2 to 7 days. When the adhesive has cured, thereby forming adhesive pads 405, the mirror 404 is attached to the flexure and backing assembly 501.

The method continues with separating the flexure and backing assembly 501 from the jig 412 (516). After this step, the flexure and backing assembly 501 corresponds to the assembly 400, where the mirror 404 is part of the assembly, although assembly 400 includes additional components as will be described.

In some implementations, the method 500 continues with installing safety catches 408. The safety catches 408 and shipping foam 410 can be elbow shaped components that attach to the backing 406 using fasteners. The shipping foam 410 can increase the chances that the mirror 404 and/or its adhesive support pads are not damaged or deformed by forces applied during shipping by damping expected vibration. Additionally, the safety catches 408 can increase the chances that the mirror will not fall and shatter on the other optical components in the X-ray device. In some implementations, the shipping foam 410 can be inserted between the mirror 404 and the safety catches 408 to further dampen forces that might occur during shipping.

In some implementations, the method 500 continues with installing the assembly 400 within a device, e.g., on mount 113. Further, the method 500 can include hooking the flexure and backing assembly 501 supporting the mirror 404 over the chassis screws, installing final screws, and tightening the chassis screws within a device, e.g., the X-ray device 100.

One having ordinary skill in the art will readily understand that the implementations discussed above may be practiced with procedures in a different order, and/or with hardware elements in configurations which are different than those which are disclosed. Therefore, although some implementations have been described based upon these some implementations, it would be apparent to those of skill in the art that certain modifications, variations, and alternative constructions would be apparent, while remaining within the spirit and scope of the implementations.

We claim:

1. A device comprising:
a backing defining a plane extending in first and second directions;
first, second, and third flexures arranged in a pattern on the backing, wherein each flexure of the first, second, and third flexures has one respective unconstrained translational degree of freedom in the plane; and
a mirror supported by the first, second, and third flexures, wherein the mirror has an optical axis, and the unconstrained translational degree of freedom of each flexure of the first, second, and third flexures is perpendicular to the optical axis,
wherein the pattern includes the first flexure at a first location, the second flexure at a second location, and the third flexure at a third location, and the first, second, and third locations are Bessel points of the mirror.

2. The device of claim 1, wherein the unconstrained translational degrees of freedom of the first, second, and third flexures are oriented to intersect at a thermal center of expansion of the mirror.

3. The device of claim 1, wherein the first, second, and third flexures are configured such that loads imposed on the mirror due to thermal variations in a range of 5° C. are less than 0.5 N.

4. The device of claim 2, wherein the first, second, and third flexures are configured such that a shape of the mirror is maintained after a thermal cycle in range of 45° C.

5. The device of claim 1, wherein the first, second, and third flexures are configured such that a shape of the mirror is maintained after accelerating up to about 29.4 m/s².

6. The device of claim 1, wherein the first, second, and third flexures are configured such that a lowest resonant frequency of the mirror is greater than 60 Hz.

7. The device of claim 1, wherein the pattern includes the first, second, and third flexures at first, second, and third locations, respectively,
wherein the first location is on a center line of the mirror, and the second and third locations are symmetric about the center line.

8. The device of claim 7, wherein a shape of the first flexure is symmetric about the center line.

9. The device of claim 1, wherein the first, second, and third flexures are all a same type of flexure.

10. The device of claim 1, wherein each flexure of the first, second, and third flexures comprises a center portion and two side portions displaced from the center portion and connected to the center portion by respective intermediate portions, and
the center portion is configured to move along the unconstrained translational degree of freedom,
the side portions are configured to remain stationary along the unconstrained translational degree of freedom.

11. The device of claim 10, wherein the center portion is connected to the side portions by connecting portions, and a dimensional extent of the connecting portions along the direction of the unconstrained translational degree of freedom is less than dimensional extents of the connecting portions along the two directions perpendicular to the unconstrained translational degree of freedom.

12. The device of claim 1, further comprising adhesive pads between the mirror and the first, second, and third flexures, wherein a material and at least one dimensional extent of each adhesive pad of the adhesive pads provide three rotational degrees of freedom for each of the first, second, and third flexures and the adhesive pads.

13. The device of claim 12, wherein the adhesive pads are cylindrical, having a height in range of 0.5 mm±10% and a diameter of 30 mm±10%.

14. The device of claim 12, wherein the material of the adhesive pads has a Young's modulus of 1.1 MPa±15%, a tensile strength of 7.1 MPa, and a coefficient of thermal expansion of 370 micron/meter/° C.±50%.

15. The device of claim 1, wherein a dimensional extent of a portion of the first, second, and third flexures is least along respective, unconstrained translational degrees of freedom of the first, second, and third flexures.

16. A system comprising:
an X-ray source configured to emit X-rays;
a scintillator arranged to absorb, on a first side of the scintillator, the X-rays, the scintillator being configured to emit light from a second side of the scintillator in response to absorption of the X-rays;
the device of claim 1, wherein the mirror is arranged to reflect the light from the second side of the scintillator toward a camera; and
the camera arranged to receive the light reflected by the mirror.

17. The system of claim 16, wherein an angle between a direction of a portion of the light when it encounters the mirror and the optical axis is acute.

18. A method comprising:
installing engineered flexures on a backing at three locations corresponding to Bessel points of a mirror, thereby forming a flexure and backing assembly;
disposing the mirror onto a jig comprising support pads disposed on a surface facing the mirror;
positioning shim jigs on the mirror;
placing the flexure and backing assembly on the jig supporting the mirror;
installing flexure spacer jigs on the engineered flexures;
injecting adhesive at adhesive injection ports on the engineered flexures;
allowing the adhesive to cure, thereby forming adhesive pads contacting the backing and the mirror;
removing the shim jigs from the mirror and the flexure spacer jigs from the engineered flexures; and
separating the flexure and backing assembly from the jig.

19. The method of claim 18, wherein installing the engineered flexures on the backing comprises aligning each engineered flexure with a corresponding through hole in the backing.

20. The method of claim 18, wherein positioning the shim jigs comprises:
sliding alignments pins through holes in the shim jigs; and
aligning recesses in the shim jigs over locations of respective adhesive pads of the adhesive pads.
